(19) United States
(12) Patent Application Publication
(10) Pub. No.: US 2026/0300082 A1
(43) Pub. Date: Oct. 1, 2026

(54) INFORMATION PROCESSING DEVICE, INFORMATION PROCESSING METHOD, AND RECORDING MEDIUM

(71) Applicant: NEC Corporation, Tokyo (JP)

(72) Inventors: Hinami Mitomi, Tokyo (JP); Kei Kojima, Tokyo (JP)

(73) Assignee: NEC Corporation, Tokyo (JP)

(21) Appl. No.: 19/567,541

(22) Filed: Mar. 16, 2026

(30) Foreign Application Priority Data
Mar. 27, 2025 (JP) 2025-052915

(51) Int. Cl. G06F 11/07; G06F 16/3332

(52) U.S. Cl. CPC G06F 11/0793; G06F 16/3334

(57) ABSTRACT

In order to support problem resolution by efficiently grasping a current state and presenting an appropriate solution by using AI, a processor of an information processing device acquires current state data regarding a current state in a theme in which a user seeks problem resolution. The processor generates a current state evaluation indicating an issue in the theme, based on the current state data. The processor acquires ideal data regarding an ideal state in the theme. The processor generates a concept of the theme, based on the ideal data. The processor compares the current state evaluation with the concept and generating a solution that leads a current state to an ideal state.

### INCORPORATION BY REFERENCE

This application is based upon and claims the benefit of priority from Japanese Patent Application 2025-052915, filed on Mar. 27, 2025, the disclosure of which is incorporated herein in its entirety by reference.

### TECHNICAL FIELD

The present disclosure relates to a technology for supporting problem resolution by using AI.

### BACKGROUND ART

In recent years, introduction of a system utilizing artificial intelligence (AI) has rapidly progressed. Specifically, a concept map generation tool utilizing AI, a work area visualization system utilizing image AI, and the like are known, and improvement in efficiency of various kinds of work and improvement in quality of work are achieved. Patent Document 1 describes a technology of supplying information according to situations of training by recognizing an action of a user and determining an emotion of the user using generative AI.

Patent Document 1: Japanese Patent Application Laid-Open under No. 2024-159558

### SUMMARY

However, problem resolution of a current state is said to be an area irreplaceable by AI. This may be because problem resolution requires combination of many processes unattainable by AI alone, such as grasping of a current state, concept definition, gap analysis, and identification of issues.

One object of the present disclosure is to provide an information processing device that supports problem resolution by efficiently grasping a current state and presenting an appropriate solution by using AI.

According to an example aspect of the present invention, there is provided an information processing device including:
at least one memory configured to store instructions; and
at least one processor configured to execute the instructions to:
acquire current state data regarding a current state in a theme in which a user seeks problem resolution;
generate a current state evaluation indicating an issue in the theme, based on the current state data;
acquire ideal data regarding an ideal state in the theme;
generate a concept of the theme, based on the ideal data; and
compare the current state evaluation with the concept and generating a solution that leads a current state to an ideal state.

According to another example aspect of the present invention, there is provided an information processing method executed by an information processing device,
the information processing method including:
acquiring current state data regarding a current state in a theme in which a user seeks problem resolution;
generating a current state evaluation indicating an issue in the theme, based on the current state data;
acquiring ideal data regarding an ideal state in the theme;
generating a concept of the theme, based on the ideal data; and
comparing the current state evaluation with the concept and generating a solution that leads a current state to an ideal state.

According to still another example aspect of the present invention, there is provided a non-transitory computer-readable recording medium storing a program causing a computer to execute processing of:
acquiring current state data regarding a current state in a theme in which a user seeks problem resolution;
generating a current state evaluation indicating an issue in the theme, based on the current state data;
acquiring ideal data regarding an ideal state in the theme;
generating a concept of the theme, based on the ideal data; and
comparing the current state evaluation with the concept and generating a solution that leads a current state to an ideal state.

### EFFECT

According to the present disclosure, it is possible to provide an information processing device that supports problem resolution by efficiently grasping a current state and presenting an appropriate solution by using AI.

### BRIEF DESCRIPTION OF THE DRAWINGS

FIG. 1 illustrates an example of a schematic configuration of a problem resolution support system according to the present disclosure;

FIG. 2 is a diagram schematically illustrating processing by a server;

FIGS. 3A and 3B are block diagrams illustrating an example of a hardware configuration of the server and a user terminal;

FIG. 4 is a block diagram illustrating an example of a functional configuration of the server;

FIG. 5 is a diagram for explaining details of a current state grasping step;

FIG. 6 illustrates an example of a customer journey map;

FIG. 7 is a diagram for explaining details of a concept generation step;

FIG. 8 illustrates an example of interaction between a user and AI;

FIG. 9 is a diagram for explaining details of a solution presentation step;

FIG. 10 is an example of a solution generation prompt;

FIG. 11 illustrates an output example of the AI according to the solution generation prompt;

FIG. 12 is a flowchart illustrating an example of solution generation processing by the server;

FIGS. 13A to 13C are diagrams for explaining an improvement process in a case where body transformation is a theme;

FIG. 14 illustrates other cases in which the problem resolution support system can be utilized;

FIG. 15 is a block diagram illustrating a functional configuration of an information processing device; and

FIG. 16 is a flowchart illustrating exemplary processing that the information processing device performs.

### EXAMPLE EMBODIMENTS

Hereinafter, example embodiments of the present disclosure will be described with reference to the drawings.

### First Example Embodiment

### Overall Configuration

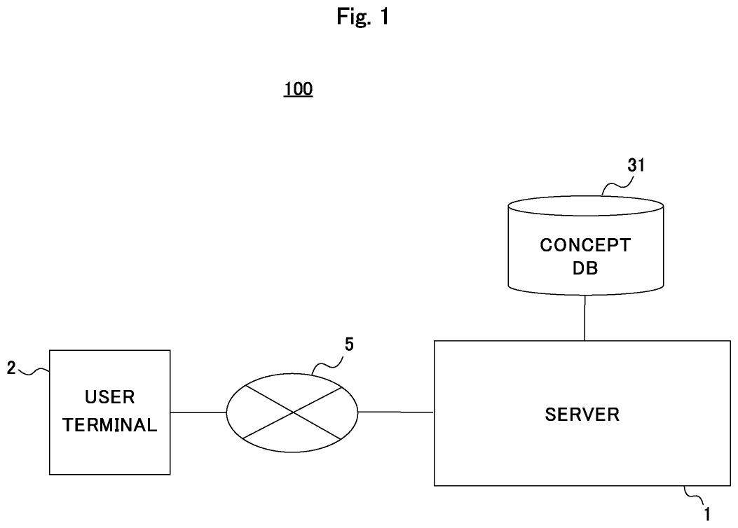

FIG. 1 is an example of a schematic configuration of a problem resolution support system 100 to which an information processing device of the present disclosure is applied. The problem resolution support system 100 is a system that presents a solution in a theme in which the user seeks problem resolution. The user is a person who seeks problem resolution in a predetermined theme.

In the problem resolution support system 100 of FIG. 1, a server 1 and a user terminal 2 are communicably connected via a network 5 such as the Internet. The server 1 is an information processing device that processes, stores, and transmits/receives various data, and is connected to a concept database (hereinafter, a “database” is referred to as a “DB”) 31.

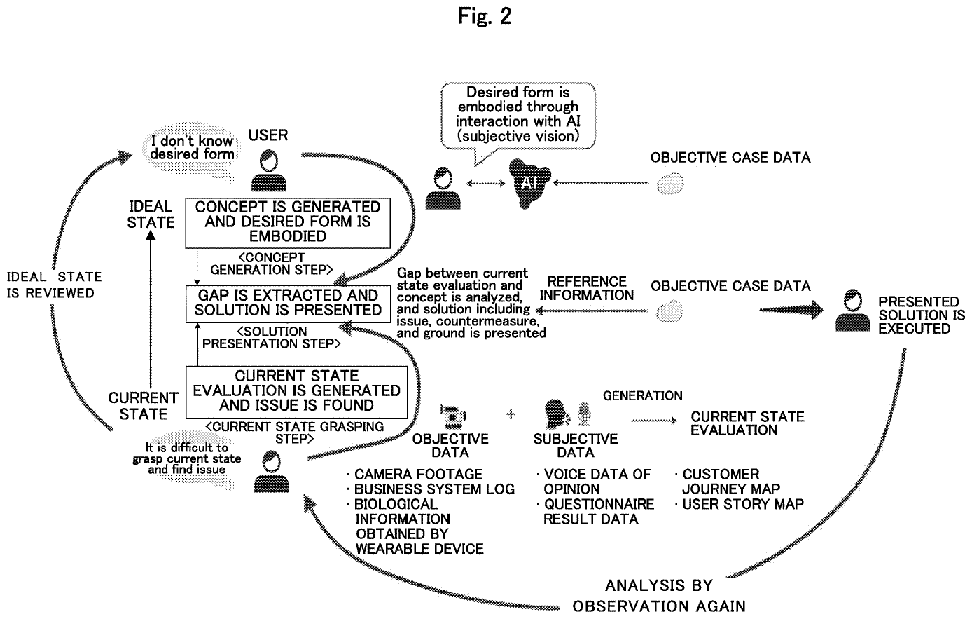

FIG. 2 is a diagram schematically illustrating processing by the server 1. As illustrated in FIG. 2, the user crystallizes a desired form regarding a theme in which the user seeks problem resolution through interaction with AI. Specifically, the AI generates a concept representing an ideal state by crystallizing subjective visions such as interests, thoughts, and inner visions of the user through interaction, with reference to objective case data. A step of generating the concept based on ideal data is also referred to as a “concept generation step”.

The user provides the server 1 with current state data regarding a current state in the theme in which the user seeks problem resolution. The current state data includes objective data and subjective data. The objective data is data with objectivity, such as, for example, footage captured by a camera for the theme, a business system log for the theme, and biological information obtained by a wearable device worn by the user or a member related to the theme (hereinafter, the “member related to the theme” is also simply referred to as a “member”). The member may include the user.

The subjective data is data with subjectivity, and is an opinion of the user or the member, such as difficulties and problems regarding the theme. As the subjective data, the server 1 acquires, for example, voice data obtained by directly recording an opinion, questionnaire data in a paper medium or in a digital form, and the like. The server 1 generates a current state evaluation visualizing an issue based on the current state data. A customer journey map and a user story map are examples of the current state evaluation. A step of generating the current state evaluation based on the current state data is also referred to as a “current state grasping step”.

Next, the server 1 analyzes a gap between the current state evaluation and the concept, generates an issue, a solution, and a ground of the solution with reference to the objective case data, and presents the issue, the solution, and the ground of the solution to the user. The user confirms and executes the presented solution. The issue, the solution, and the ground of the solution are also collectively referred to simply as a “solution”. A step of generating the solution based on the current state evaluation and the concept and presenting the solution is also referred to as a “solution presentation step”.

After the user actually executes the solution presented in the solution presentation step, the problem resolution support system 100 performs analysis by observation again. Specifically, the problem resolution support system 100 executes the current state grasping step again, to find a new issue after execution of the solution. The ideal state is also reviewed as necessary. By repeating an improvement process including the current state grasping step, the concept generation step, and the solution presentation step, the problem resolution support system 100 supports the user to solve a problem and approach the ideal state in the predetermined theme.

The server 1 is an information processing device that processes, stores, and transmits/receives various data by using generative AI, and receives current state data and ideal data from the user terminal 2 and transmits a generated solution to the user terminal 2. The server 1 is connected to the concept DB 31 to be described later. The server 1 may be a virtual server in a cloud environment. The server 1 is an example of an information processing device according to the present disclosure.

The user terminal 2 is a smartphone, a tablet, a PC, or the like used by the user, transmits current state data and ideal data to the server 1, and receives a solution from the server 1 and displays the solution.

### Hardware Configuration

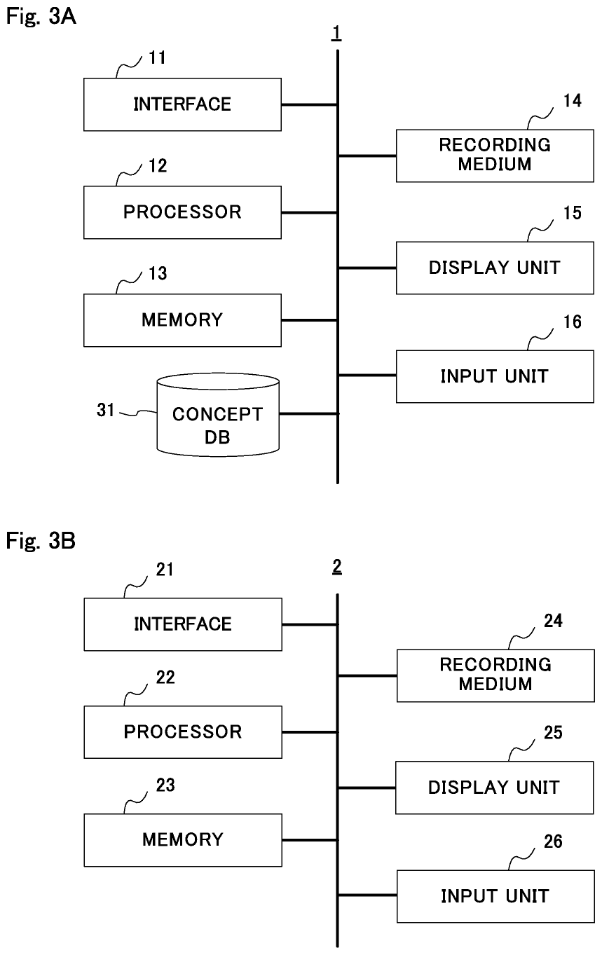

FIG. 3A is a block diagram illustrating an example of a hardware configuration of the server 1. As illustrated in the drawing, the server 1 includes an interface 11, a processor 12, a memory 13, a recording medium 14, a display unit 15, and an input unit 16. These components and the concept DB 31 are connected to each other via a bus.

The interface 11 exchanges data with the user terminal 2. The interface 11 is used to receive the current state data and the ideal data from the user terminal 2 and transmit a generated solution to the user terminal 2.

The processor 12 is a computer such as a central processing unit (CPU), and controls the entire server 1 by executing a program prepared in advance. As the processor 12, it is possible to use a CPU, a graphics processing unit (GPU), a Digital Signal Processor (DSP), a Micro Processing Unit (MPU), a Floating Point Unit (FPU), a Physics Processing Unit (PPU), a Tensor Processing Unit (TPU), a quantum processor, a microcontroller, a combination of these, or the like.

The memory 13 includes a read only memory (ROM), a random access memory (RAM), and the like. The memory 13 stores a program executed by the processor 12. The memory 13 is also used as a working memory during execution of various types of processing by the processor 12.

The recording medium 14 is a non-volatile and non-transitory recording medium such as a disk-shaped recording medium or a semiconductor memory, and is attachable to and detachable from the server 1. The recording medium 14 records various programs to be executed by the processor 12. In order for the server 1 to perform solution generation processing, which will be described later, a program recorded on the recording medium 14 is loaded into the memory 13 and the processor 12 executes the program.

The display unit 15 is, for example, a liquid crystal display (LCD), and displays various images while the server 1 is operating. The input unit 16 is a keyboard, a mouse, a touch panel, or the like, and is used by an operator who manages the server 1.

The concept DB 31 stores a concept generated by the server 1, keywords related to the concept, and the like in association with each other.

FIG. 3B is a block diagram illustrating an example of a hardware configuration of the user terminal 2. As illustrated in the drawing, the user terminal 2 includes an interface 21, a processor 22, a memory 23, a recording medium 24, a display unit 25, and an input unit 26.

The interface 21 exchanges data with the server 1 via the network 5. The interface 21 is used to transmit current state data and ideal data to the server 1 and receive a solution from the server 1.

The processor 22 is a computer such as a CPU, and controls the entire user terminal by executing a program prepared in advance. As the processor 22, it is possible to use a CPU, a GPU, a DSP, an MPU, an FPU, a PPU, a TPU, a quantum processor, a microcontroller, a combination of these, or the like.

The memory 23 includes a ROM, a RAM, or the like. The memory 23 stores a program executed by the processor 22. The memory 23 is also used as a working memory during execution of various types of processing by the processor 22.

The recording medium 24 is a non-volatile non-transitory recording medium such as a disk-shaped recording medium or a semiconductor memory, and is attachable to and detachable from the user terminal 2. The recording medium 24 records various programs to be executed by the processor 22. The display unit 25 is, for example, an LCD, and displays various images while the user is operating the user terminal 2. The input unit 26 is a touch panel or the like, and is used in a case where the user performs a predetermined operation.

### Functional Configuration

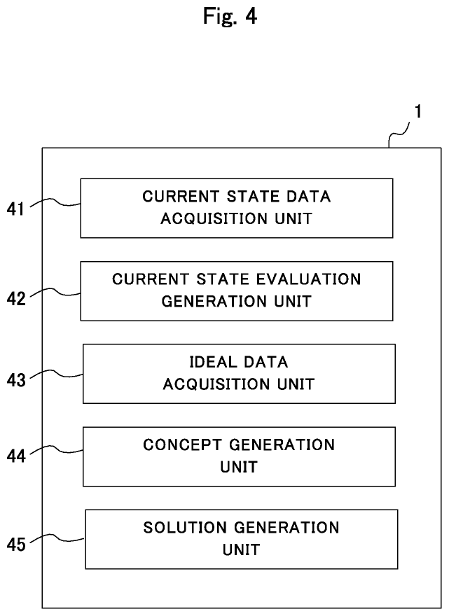

FIG. 4 is a block diagram illustrating an example of a functional configuration of the server 1. The server 1 functionally includes a current state data acquisition unit 41, a current state evaluation generation unit 42, an ideal data acquisition unit 43, a concept generation unit 44, and a solution generation unit 45.

The current state data acquisition unit 41, the current state evaluation generation unit 42, the ideal data acquisition unit 43, the concept generation unit 44, and the solution generation unit 45 are implemented by the processor 12 executing a program.

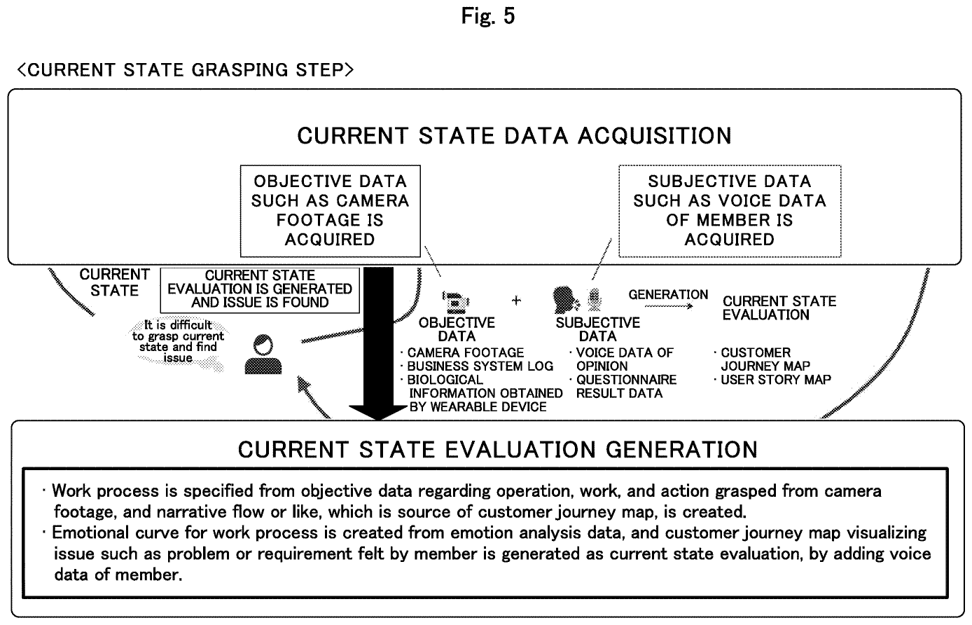

The current state data acquisition unit 41 acquires current state data of a theme in which the user seeks problem resolution. As an example, a case will be described in which the user is a warehouse manager who manages a distribution warehouse, and a theme is improvement of the distribution warehouse. FIG. 5 is a diagram for explaining details of the current state grasping step in which improvement of the distribution warehouse is set as a theme.

First, as illustrated in FIG. 5, the current state data acquisition unit 41 acquires, as current state data, objective data such as camera footage and subjective data such as voice data of the member. Specifically, the current state data acquisition unit 41 acquires, as the objective data, footage from a camera installed in the distribution warehouse, biological information obtained by a wearable device worn by the member working in the distribution warehouse, and the like, from the user terminal 2. For example, the user installs a microphone for freely asking for an opinion regarding difficulties, problems, requirements, and the like at a site of the distribution warehouse, and the current state data acquisition unit 41 acquires, as the subjective data, voice data as opinion of the member working in the distribution warehouse from the user terminal 2.

Since it is desirable that the subjective data be an honest opinion, anonymity of the member who gives the opinion may be secured. In addition to asking the member to speak to the installed microphone, any method can be applied as a method for acquiring an opinion of the member, such as asking the member to speak while camera footage is being recorded, write an opinion on an installed tablet, respond to a questionnaire in a paper medium or in a digital form, post to an installed difficulty box, and the like.

The current state evaluation generation unit 42 generates a current state evaluation for finding an issue of the theme, based on the current state data. Specifically, the current state evaluation generation unit 42 grasps an actual state of the site based on the objective data and the subjective data. For example, the current state evaluation generation unit 42 acquires data regarding operations, work, and actions in the warehouse by grasping a person, the number of persons, and a work time and a work content of each person from camera footage by using AI. The current state evaluation generation unit 42 generates emotion analysis data by using AI, based on biological information of the member acquired by the wearable device. Stress and the like of the member can be detected from the emotion analysis data.

A site visualization technique for grasping a person, the number of persons, and a work time and a work content of each person from camera footage by using AI, and an emotion analysis technique for generating the emotion analysis data based on the biological information acquired by the wearable device by using AI are well known, and thus a description thereof will be omitted for convenience.

Next, as illustrated in FIG. 5, the current state evaluation generation unit 42 generates a current state evaluation for finding an issue. For example, the current state evaluation generation unit 42 specifies a work process from data regarding operations, work, and actions on the site, and creates a narrative flow or the like that is a source of the customer journey map. The current state evaluation generation unit 42 detects stress (pain) and gain during work from the emotion analysis data of the member working on the site, identifies an emotion for the work process, creates an emotional curve, and the like. The current state evaluation generation unit 42 grasps and visualizes an issue such as a problem or a requirement felt by the member working on the site, by adding voice data of the member to the created narrative flow and the created emotional curve for the work process. The current state evaluation generation unit 42 generates these as the current state evaluation such as the customer journey map.

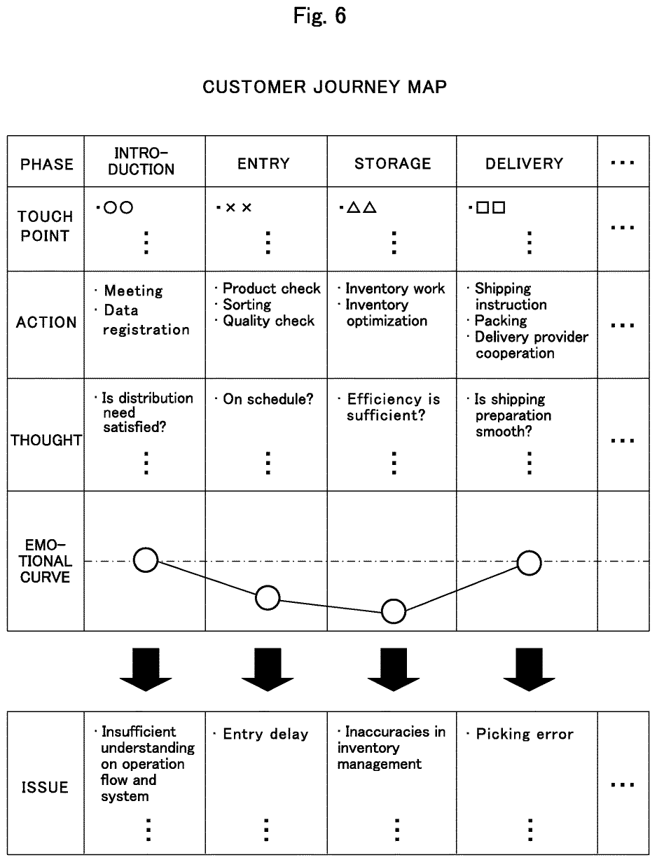

FIG. 6 illustrates an example of the customer journey map. As illustrated in FIG. 6, the customer journey map illustrates touch points, actions, thoughts, and emotional curves of a member in each phase, and visualizes issues derived therefrom.

The ideal data acquisition unit 43 acquires ideal data regarding an ideal state in the theme in which the user seeks problem resolution. In a case of problem resolution of a predetermined theme, there may be a problem that the user is not able to envision the ideal state due to lack of knowledge or the like, or it is difficult to verbalize and express his/her vision. For example, in a case where the user is a warehouse manager of a distribution warehouse, it is conceivable that the user wants to improve a site for continuing business, but is not able to specifically envision where to start, what should be preferentially performed, and what is a desirable state in the first place.

Therefore, the ideal data acquisition unit 43 crystallizes the ideal state by causing the user to interact with AI, and acquires an interaction content as the ideal data. Specifically, the user interacts with the AI by voice or text using a chat screen or the like displayed on the user terminal 2, based on information received from the server 1. The AI used here includes various types of conversational AI utilizing a large-scale language model (LLM) including ChatGPT.

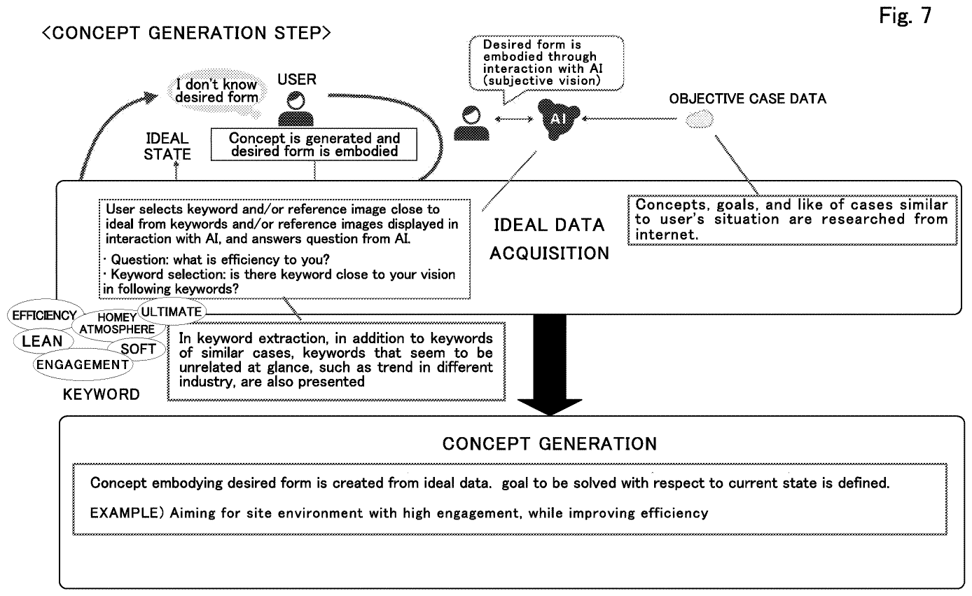

FIG. 7 is a diagram for explaining details of the concept generation step in which improvement of a distribution warehouse is set as a theme. As illustrated in FIG. 7, the user selects a keyword and/or a reference image close to an ideal from keywords and/or reference images displayed in interaction with the AI, and answers a question from the AI.

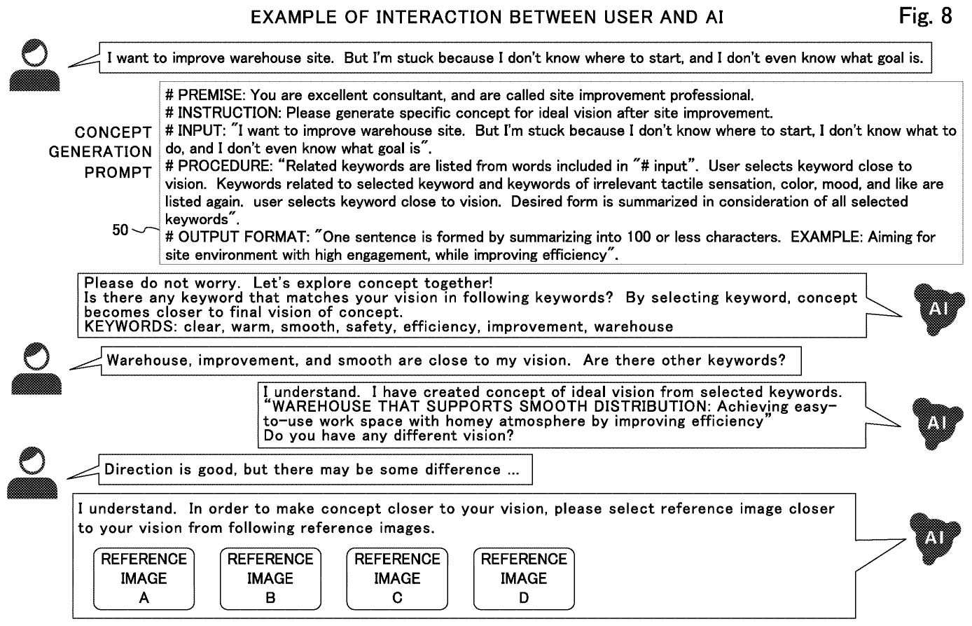

FIG. 8 illustrates an example of interaction between the user and the AI. For example, as illustrated in FIG. 8, it is assumed that the user inputs “I want to improve the warehouse site, but I'm stuck because I don't know where to start, and I don't even know what a goal is”, as the theme in which the user seeks problem resolution. In this case, the ideal data acquisition unit 43 generates a concept generation prompt 50 illustrated in FIG. 8 and inputs the concept generation prompt 50 to the AI, and the AI interacts with the user based on the concept generation prompt 50.

Specifically, as illustrated in FIG. 8, the AI gives words of “Please do not worry. Let's explore the concept together! Is there any keyword that matches your vision? By selecting the keyword, the concept becomes closer to a final vision. KEYWORDS: clear, warm, smooth, safety, efficiency, improvement, warehouse” to the user, and presents the keywords. At this time, in addition to keywords of cases similar to the theme, useful keywords having a low degree of relevance with the theme are also presented, for example, keywords that seem to be unrelated at a glance, such as a trend in a different industry.

As illustrated in FIG. 8, in a case where the user selects “warehouse, improvement, smooth” from the presented keywords, the ideal data acquisition unit 43 acquires the selected keywords as keywords close to the ideal.

As illustrated in FIG. 8, the AI gives words of “I understand. In order to make the concept closer to your vision, please select a reference image closer to your vision from the following reference images” to the user, and presents reference images A to D. The ideal data acquisition unit 43 acquires a reference image selected by the user as a reference image close to the ideal.

In this manner, the AI advances the interaction with the user while presenting keywords and/or reference images and making a question in order to crystallize an ideal state and a target form the user is not able to express with words, based on the concept generation prompt 50.

As illustrated in FIG. 7, the ideal data acquisition unit 43 searches for concepts, goals, and the like of cases similar to the ideal state of the user from the Internet, and acquires the concepts, the goals, and the like as objective case data. The objective case data may be based on overseas cases.

The concept generation unit 44 generates a concept representing the ideal state in the theme, based on the ideal data. Specifically, the concept generation unit 44 generates a concept representing the ideal state of the user by referring to an answer of the user and combining the keyword close to the ideal and the reference image close to the ideal, which are selected by the user. In other words, the concept defines a goal to be solved with respect to a current state. At this time, the concept generation unit 44 may generate the concept with reference to the objective case data researched from the Internet.

For example, in a case where the theme is improvement of a distribution warehouse, as illustrated in FIG. 7, the concept generation unit 44 generates a concept appropriately representing the ideal state of the user, such as “aiming for a site environment with high engagement, while improving efficiency”, “increasing productivity and efficiency”, or “aiming for a site where anyone can work”, by combining the keyword and/or the reference image close to the ideal, based on the ideal data. The concept generation unit 44 may present the generated concept in the interaction with the user, and adopt a concept that is affirmed or selected by the user.

The concept generation unit 44 stores the generated concept in the concept DB 31. At this time, the concept generation unit 44 may store the theme, the keyword close to the ideal, the reference images close to the ideal, and the like in association with the generated concept. In a case of presenting the keywords and/or the reference images in the interaction with the user, the ideal data acquisition unit 43 may refer to the concept DB 31, and determine a keyword to be included in the keyword and/or a reference image to be included in the reference images with reference to a past concept.

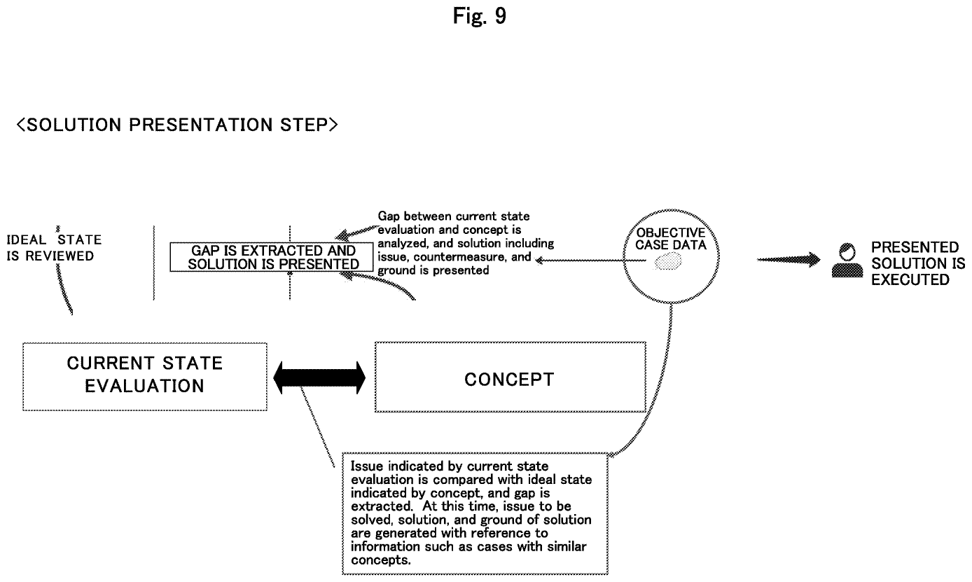

The solution generation unit 45 compares the current state evaluation with the concept, and generates and outputs a solution for leading a current state to an ideal state. FIG. 9 is a diagram for explaining details of the solution presentation step in which improvement of a distribution warehouse is set as a theme. As illustrated in FIG. 9, the solution generation unit 45 compares the current state evaluation with the concept to perform gap analysis, and extracts a gap. Specifically, the solution generation unit 45 compares an issue indicated by the current state evaluation with an ideal state indicated by the concept, and extracts the gap.

The solution generation unit 45 performs research on information such as cases having similar concepts on the Internet, and acquires the information as the objective case data. The objective case data may be based on overseas cases, and the solution generation unit 45 performs research, for example, another person's case that has succeeded in a distribution warehouse, on a global basis.

The solution generation unit 45 refers to the objective case data, and generates and outputs an issue to be solved in the theme, a solution, and a ground of the solution, based on the gap extracted by comparing the current state evaluation with the concept. Specifically, the solution generation unit 45 generates a solution for the theme by inputting the current state evaluation, the concept, and a solution generation prompt to the AI.

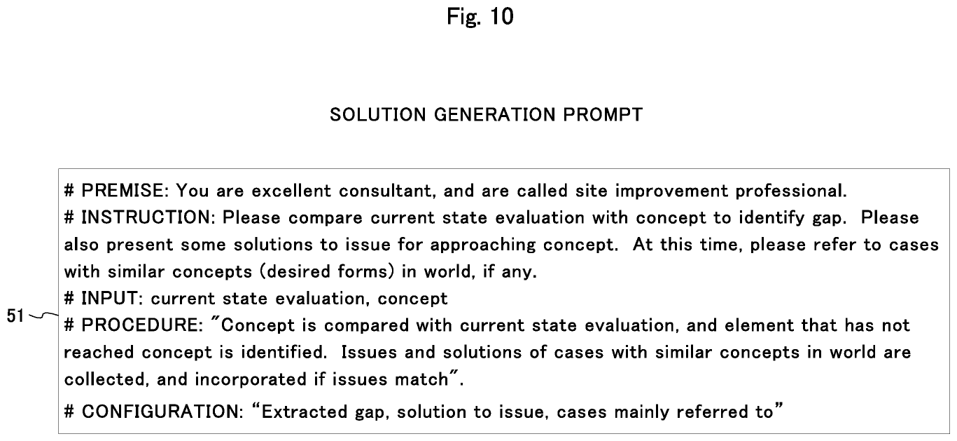

FIG. 10 is an example of the solution generation prompt. As illustrated in FIG. 10, a solution generation prompt 51 causes the AI to compare the concept with the current state evaluation to extract, as a gap, an element that has not reached the concept, and to output the extracted gap, a solution to the issue, and cases mainly referred to, based on cases with similar concepts in the world.

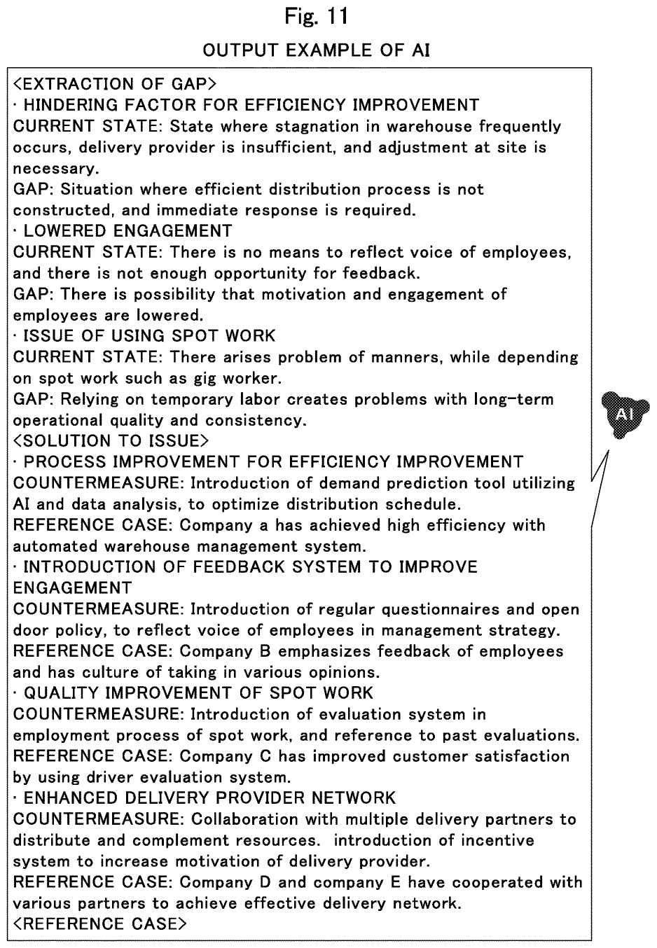

FIG. 11 illustrates an output example of the AI according to the solution generation prompt 51. As illustrated in FIG. 11, in the output example, as the extraction of the gap, for example, an issue “hindering factor for efficiency improvement”, a current state with respect to the issue, and a gap with respect to the issue are output. As illustrated in FIG. 11, in the output example, for example, “process improvement for efficiency improvement” and a specific countermeasure “introduction of a demand prediction tool utilizing AI and data analysis to optimize distribution schedule” are output as a solution to the issue. As a ground of the solution, for example, a reference case “Company A has achieved high efficiency with an automated warehouse management system” is output.

In this way, by inputting the concept, the current state evaluation, and the solution generation prompt 51 to the AI, the solution generation unit 45 generates and presents, to the user, the issue of the theme, the solution of the issue, and the ground of the solution. As a result, in addition to a countermeasure to be executed for problem resolution, the issue for problem resolution, the solution to the issue, and the ground of the solution are presented, and thus the user can execute the solution with confidence.

Without limiting to a text format, the issue may be indicated by, for example, a graph such as an emotional curve for a work process of the theme, and the solution of the issue and the ground of the solution may be indicated by a chart or the like. That is, the formats indicating the issue, the solution, and the ground of the solution can be freely set.

In a case where the user confirms and executes the presented solution, the server 1 performs the current state grasping step again, and finds a new issue after execution of the solution. The server 1 also reviews the ideal state as necessary, and repeats the improvement process including the current state grasping step, the concept generation step, and the solution presentation step, to give support to bring the current state of the user closer to the ideal state in the predetermined theme.

In the above configuration, the current state data acquisition unit 41, the current state evaluation generation unit 42, the ideal data acquisition unit 43, the concept generation unit 44, and the solution generation unit 45 of the server 1 are examples of a current state data acquisition means, a current state evaluation generation means, an ideal data acquisition means, a concept generation means, and a solution generation means of the present disclosure, respectively.

### Solution Generation Processing

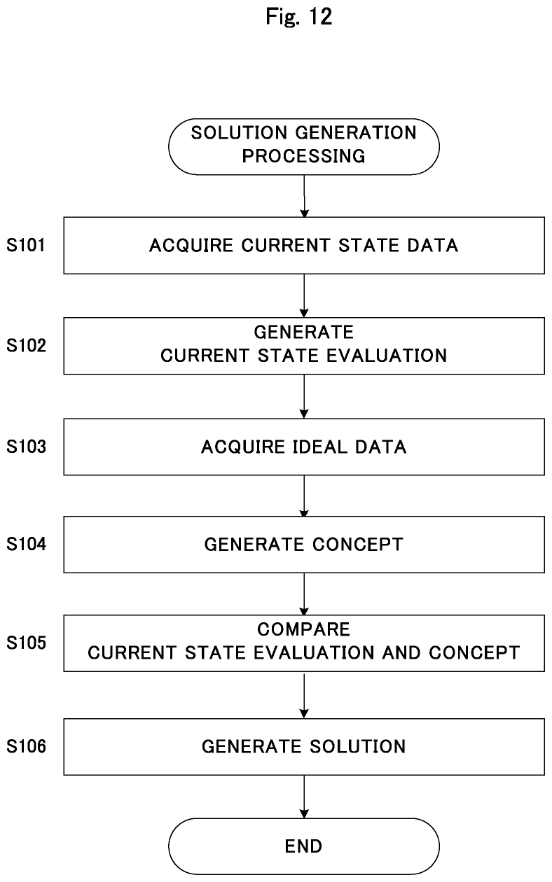

Next, the solution generation processing by the server 1 will be described. FIG. 12 is a flowchart illustrating an example of the solution generation processing by the server 1. This processing is achieved by the processor 12 illustrated in FIG. 3A and FIG. 3B executing a program prepared in advance.

First, the server 1 acquires current state data including objective data and subjective data of a theme, from the user terminal 2 (step S101). Based on the current state data, the server 1 generates a current state evaluation indicating an issue of the theme (step S102). By interacting with the user via the user terminal 2 with reference to the objective case data, the server 1 crystallizes an ideal state in the theme, and acquires an interaction content as ideal data (step S103). Based on the ideal data, the server 1 generates a concept representing an ideal state (step S104).

Next, the server 1 analyzes a gap between the current state evaluation and the concept, and generates an issue, a solution, and a ground of the solution with reference to the objective case data (step S106). The user terminal 2 presents the issue, the solution, and the ground of the solution, by acquiring the issue, the solution, and the ground of the solution from the server 1 and displaying the issue, the solution, and the ground of the solution. In this way, the solution generation processing ends.

Conventionally, in order to grasp a current state in a theme in which problem resolution is sought, user investigation through observation and empathy is often performed as a technique of user experience design. However, this requires user experience (UX) expertise, upstream expertise of system development, and domain knowledge, and high skill and a lot of time are required to grasp the current state through explanations and questions of the user. In particular, in a case where the explanations of the user are insufficient or subjectively biased, it is important to check on an objective fact basis and to go deep into insight by a UX researcher. A person in charge of a site, who is a user, or a worker himself/herself in the site often does not grasp an essential problem or issue, and accurate grasping of a current state is an essential requirement for success in improvement as a first step in problem resolution.

In the related art, a current state is grasped by analysis using an algorithm defined as an objective fact. The problem resolution support system 100 of the present disclosure automates UX research based on an idea of human-centered design, to grasp a current state. Specifically, in the current state grasping step, the problem resolution support system 100 acquires current state data such as camera footage, a business system log, and voice data of the user, and combines outputs of an on-site visualization technique and an emotion analysis technique based on objective data and subjective data included in the current state data, to generate a current state evaluation visualizing an issue. As a result, it is possible to accurately grasp the current state.

In a case of improving and optimizing a site for problem resolution, it is difficult to envision an ideal state unless the person is an experienced consultant or an expert. Even if there is a vague vision of a target form, it is difficult to verbalize and express the vision to others. The related art is to grasp an ideal state by performing logical analysis based on a rule-based algorithm, and thus has been unable to solve these issues. On the other hand, the problem resolution support system 100 of the present disclosure can generate a specific concept representing an ideal state, even if the user does not know the clear ideal state, by prompting the user to output a latent vision and repeat divergence and convergence for what the user wants to do and does not want to do, in interaction with the AI.

Conventionally, a consultant or an expert generates a solution using logical thinking, but the problem resolution support system 100 automatically generates a solution by comparing and analyzing a current state evaluation and a concept. In this way, according to the problem resolution support system 100, even if the user has little expertise, the user can crystallize a latent ideal vision in a theme in which the user seeks problem resolution, and easily acquire an issue, a solution, and a ground of the solution. Therefore, the user can achieve problem resolution without having to pay an expensive cost to a consultant, and can deepen understanding on the site.

### First Modification Example

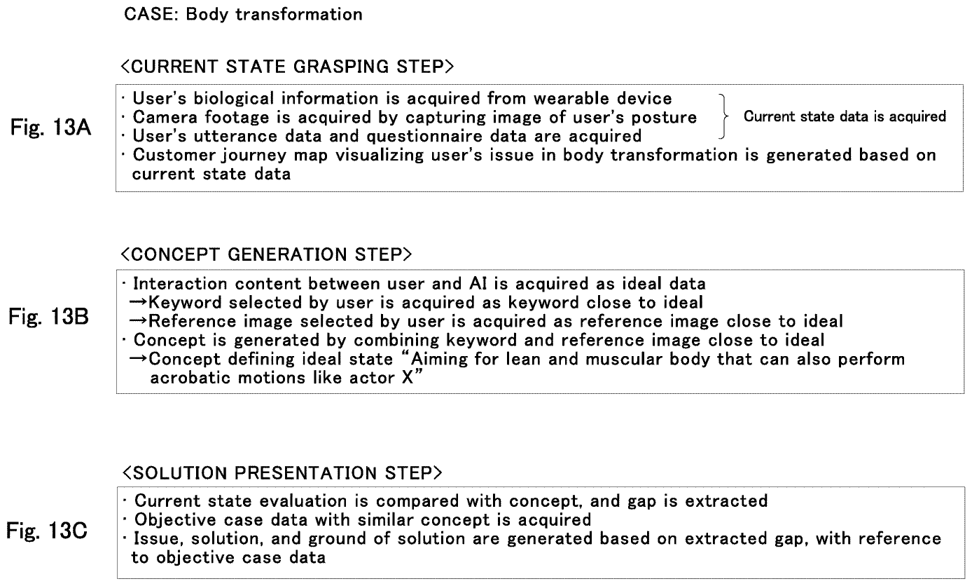

In the first example embodiment, a description is given to a case where improvement of a distribution warehouse executed by a plurality of members including the user is the theme. However, the present invention is not limited to this, and the problem resolution support system 100 can be applied to a theme executed by one user. Here, as an example, a case where body transformation is a theme will be described. FIG. 13A to FIG. 13C are diagrams for explaining a current state grasping step, a concept generation step, and a solution presentation step, respectively, in a case where body transformation is a theme.

As illustrated in FIG. 13A, in the current state grasping step, the current state data acquisition unit 41 acquires biological information of a user as objective data, by using a wearable device such as a smart watch worn by the user. If the user desires, the current state data acquisition unit 41 captures, with a camera, an image of a posture and the like of the user without being specially conscious of the camera during work or the like, and acquires camera footage as objective data. The current state data acquisition unit 41 acquires, as subjective data, utterance data of the user, questionnaire data of the user that can be registered by using an application or the like, and the like.

The current state evaluation generation unit 42 grasps a health condition of the user from the biological information of the user, and acquires action data and health data (transition of body temperature, blood pressure, and the like). The current state evaluation generation unit 42 generates emotion analysis data by utilizing an emotion analysis technique based on the biological information of the user, and detects daily stress (pain) and gain. The current state evaluation generation unit 42 specifies an action process of the user based on the action data of the user, health data, camera footage, and the like, and creates a narrative flow and the like. The current state evaluation generation unit 42 specifies an emotion for the action process from the emotion analysis data, and the like. Next, the current state evaluation generation unit 42 adds the utterance data and questionnaire data of the user to the created narrative flow and an emotional curve for the action process, and generates a customer journey map visualizing an issue of the user in body transformation, as a current state evaluation.

As illustrated in FIG. 13B, in the concept generation step, the ideal data acquisition unit 43 acquires, as ideal data, an interaction content crystallizing a state that is ideal for the user in body transformation. For example, in a case where the user vaguely desires to become like a model or an actor, the user selects a keyword and/or a reference image of a desired form from keywords and/or reference images presented in interaction with the AI. The ideal data acquisition unit 43 acquires the keyword and/or the reference image selected by the user as a keyword and/or a reference image close to the ideal of the user. The concept generation unit 44 generates a concept such as “aiming for a lean and muscular body that can also perform acrobatic motions like the actor X”, for example, by combining the keyword and/or the reference image close to the ideal while referring to an answer of the user.

As illustrated in FIG. 13C, in the solution presentation step, the solution generation unit 45 compares the current state evaluation with the concept to perform gap analysis, and extracts a gap. The solution generation unit 45 performs research on information such as cases having similar concepts from the Internet, and acquires the information as objective case data. For example, information or the like on accounts that share progress of body transformation on a social networking service (SNS) is researched on a global basis. Next, the solution generation unit 45 refers to the objective case data, and generates an issue to be solved in body transformation, a solution, and a ground of the solution, based on the gap extracted by comparing the current state evaluation with the concept. The generated issue, solution, and ground of the solution are transmitted to the user terminal 2 and presented to the user. In a case where the solution of body transformation is an action plan, the solution generation unit 45 can generate and output the solution of body transformation in any format such as a table.

In this way, the problem resolution support system 100 can also be applied to a theme executed by one user. According to the problem resolution support system 100, it is possible to crystallize vague feelings of the user such as “I need to lose weight”, “I want to build muscles”, “I want to be healthier”, and “I want to be like the actor X” through interaction with the AI. For “I want to be like the actor X”, for example, “why do I want to be like the actor X”, “what appeals to me about the actor X”, and the like are extracted from the user in the interaction with the AI, and crystallized to “I want to build muscles”, “I want to look thin”, “I want to have a functional body”, or the like. As a result, the user can specifically envision the ideal state, and the problem resolution support system 100 can present the user with an appropriate solution for approaching the ideal state.

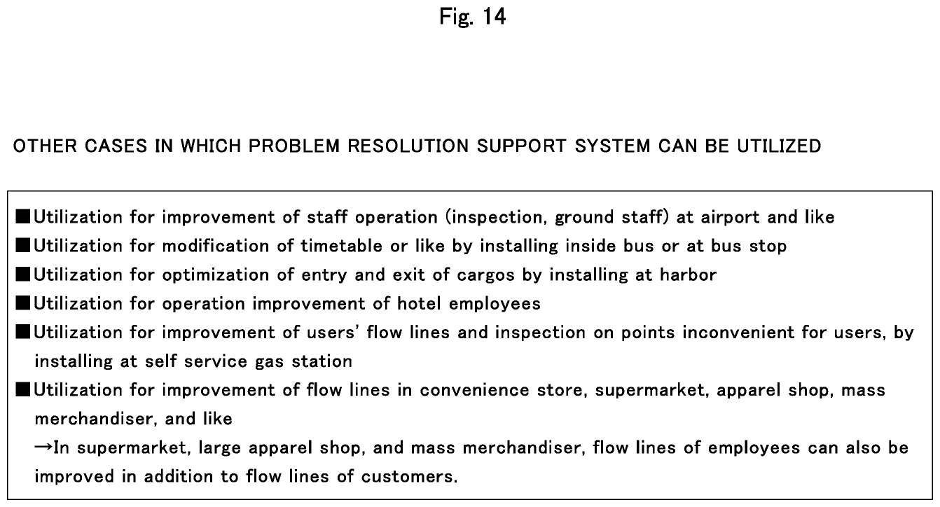

Without limiting to improvement of a distribution warehouse and body transformation, the problem resolution support system 100 can be used for various cases. FIG. 14 illustrates other cases in which the problem resolution support system 100 can be utilized. As illustrated in FIG. 14, the problem resolution support system 100 can be utilized for improvement of staff operation at an airport and the like, modification of a timetable, optimization of entry and exit of cargos at a harbor, operation improvement of hotel employees, improvement of users' flow lines and inspection on points inconvenient for users at a self service gas station, improvement of flow lines of employees and customers in a store, and the like.

### Second Modification Example

In the current state grasping step, the server 1 may output the current state evaluation such as the customer journey map, and for example, a consultant or the like may rework the current state evaluation as necessary. In this case, the server 1 can generate a more appropriate solution by using the current state evaluation after reworking in the solution presentation step.

### Second Example Embodiment

FIG. 16 is a block diagram illustrating an example of functional configuration of an information processing device according to the present disclosure. An information processing device 90 includes a current state data acquisition means 91, a current state evaluation generation means 92, an ideal data acquisition means 93, a concept generation means 94, and a solution generation means 95.

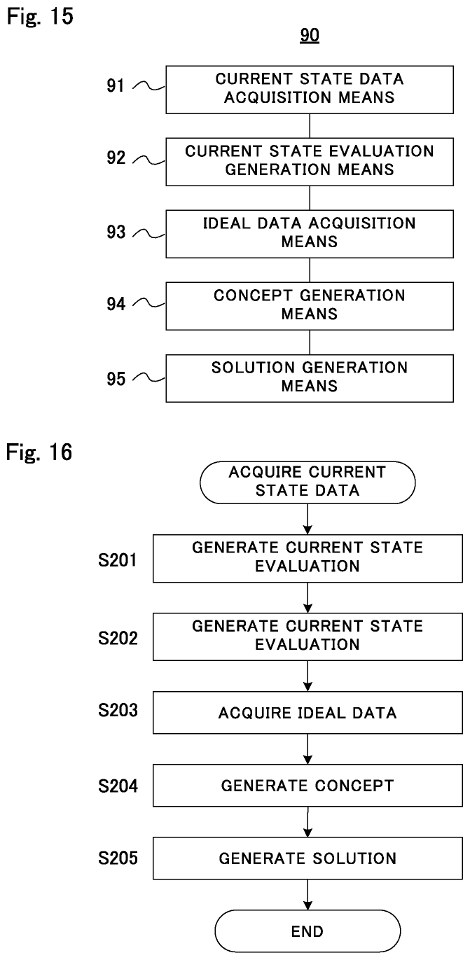

FIG. 15 is a flowchart illustrating an example of processing by the information processing device 90. The current state data acquisition means 91 acquires current state data regarding a current state in a theme in which a user seeks problem resolution (step S201). Based on the current state data, the current state evaluation generation means 92 generates a current state evaluation indicating an issue of the theme (step S202). The ideal data acquisition means 93 acquires ideal data regarding an ideal state in the theme (step S203). Based on the ideal data, the concept generation means 94 generates a concept of the theme (step S204). The solution generation means 95 compares the current state evaluation with the concept, and generates a solution that leads the current state to the ideal state (step S205). According to the information processing device 90, it is possible to support problem resolution by efficiently grasping a current state and presenting an appropriate solution by using AI.

Additionally, some or all of the above example embodiments (including modification examples, the same applies below) may also be described as follows, but are not limited to the following.

A part or all of the example embodiments described above may also be described as the following supplementary notes, but not limited thereto.

### Supplementary Note 1

An information processing device including:
a current state data acquisition means configured to acquire current state data regarding a current state in a theme in which a user seeks problem resolution;
a current state evaluation generation means configured to generate a current state evaluation indicating an issue in the theme, based on the current state data;
an ideal data acquisition means configured to acquire ideal data regarding an ideal state in the theme;
a concept generation means configured to generate a concept of the theme, based on the ideal data; and
a solution generation means configured to compare the current state evaluation with the concept and generating a solution that leads a current state to an ideal state.

### Supplementary Note 2

The information processing device according to Supplementary Note 1, wherein the ideal data acquisition means acquires, as ideal data, an interaction content between a user and generative AI.

### Supplementary Note 3

The information processing device according to Supplementary Note 1, wherein
the ideal data acquisition means acquires a keyword selected by the user from a plurality of keywords, as a keyword close to an ideal, and
the concept generation means generates a concept based on a keyword close to an ideal, by using generative AI.

### Supplementary Note 4

The information processing device according to Supplementary Note 3, wherein a keyword included in the keywords is determined with reference to a past concept related to the theme.

### Supplementary Note 5

The information processing device according to Supplementary Note 3, wherein the keywords include a useful keyword having a low degree of relevance with the theme.

### Supplementary Note 6

The information processing device according to Supplementary Note 3, wherein
the ideal data acquisition means acquires a reference image selected by the user from a plurality of reference images, as a reference image close to an ideal, and
the concept generation means generates a concept by combining a keyword close to an ideal and a reference image close to an ideal by using generative AI.

### Supplementary Note 7

The information processing device according to Supplementary Note 1, wherein
the current state data includes objective data and subjective data, and
the current state evaluation generation means generates a current state evaluation including a process and an emotion for the process, by specifying the process of the theme, based on the objective data and specifying the emotion for the process based on the objective data and the subjective data.

### Supplementary Note 8

The information processing device according to Supplementary Note 1, wherein the solution generation means generates the issue, a solution to the issue, and a ground of the solution, by referring to external data similar to the theme and the concept.

### Supplementary Note 9

An information processing method executed by an information processing device,
the information processing method including:
acquiring current state data regarding a current state in a theme in which a user seeks problem resolution;
generating a current state evaluation indicating an issue in the theme, based on the current state data;
acquiring ideal data regarding an ideal state in the theme;
generating a concept of the theme, based on the ideal data; and
comparing the current state evaluation with the concept and generating a solution that leads a current state to an ideal state.

### Supplementary Note 10

A program causing a computer to execute processing including:
acquiring current state data regarding a current state in a theme in which a user seeks problem resolution;
generating a current state evaluation indicating an issue in the theme, based on the current state data;
acquiring ideal data regarding an ideal state in the theme;
generating a concept of the theme, based on the ideal data; and
comparing the current state evaluation with the concept and generating a solution that leads a current state to an ideal state.

Some or all of the configurations described in Supplementary Notes 2 to 8 dependent on the above-described Supplementary Note 1 can also be dependent on Supplementary Notes 9 and 10 by the same dependency relationship as in Supplementary Notes 2 to 8. Furthermore, some or all of the configurations described as Supplementary Notes can be similarly dependent on not only Supplementary Notes 1, 9, and 10, but also various pieces of hardware and software, and various recording means or systems for recording software without departing from the above-described example embodiments.

While the present disclosure has been described with reference to the example embodiments and examples, the present disclosure is not limited to the above example embodiments and examples. Various changes which can be understood by those skilled in the art within the scope of the present disclosure can be made in the configuration and details of the present disclosure.

### DESCRIPTION OF SYMBOLS

1 Server
2 User terminal
11, 21 Interface
12, 22 Processor
13, 23 Memory
14, 24 Recording medium
15, 25 Display unit
16, 26 Input unit
31 Concept DB
41 Current state data acquisition unit
42 Current state evaluation generation unit
43 Ideal data acquisition unit
44 Concept generation unit
45 Solution generation unit
100 Problem resolution support system

1. An information processing device comprising:
at least one memory configured to store instructions; and
at least one processor configured to execute the instructions to:
acquire current state data regarding a current state in a theme in which a user seeks problem resolution;
generate a current state evaluation indicating an issue in the theme, based on the current state data;
acquire ideal data regarding an ideal state in the theme;
generate a concept of the theme, based on the ideal data; and
compare the current state evaluation with the concept and generating a solution that leads a current state to an ideal state.

2. The information processing device according to claim 1, wherein the processor acquires, as ideal data, an interaction content between a user and generative AI.

3. The information processing device according to claim 1, wherein
the processor acquires a keyword selected by the user from a plurality of keywords, as a keyword close to an ideal, and
the processor generates a concept based on a keyword close to an ideal, by using generative AI.

4. The information processing device according to claim 3, wherein a keyword included in the keywords is determined with reference to a past concept related to the theme.

5. The information processing device according to claim 3, wherein the keywords include a useful keyword having a low degree of relevance with the theme.

6. The information processing device according to claim 3, wherein
the processor acquires a reference image selected by the user from a plurality of reference images, as a reference image close to an ideal, and
the processor generates a concept by combining a keyword close to an ideal and a reference image close to an ideal by using generative AI.

7. The information processing device according to claim 1, wherein
the current state data includes objective data and subjective data, and
the processor generates a current state evaluation including a process and an emotion for the process, by specifying the process of the theme, based on the objective data and specifying the emotion for the process based on the objective data and the subjective data.

8. The information processing device according to claim 1, wherein the processor generates the issue, a solution to the issue, and a ground of the solution, by referring to external data similar to the theme and the concept.

9. An information processing method executed by an information processing device,
the information processing method comprising:
acquiring current state data regarding a current state in a theme in which a user seeks problem resolution;
generating a current state evaluation indicating an issue in the theme, based on the current state data;
acquiring ideal data regarding an ideal state in the theme;
generating a concept of the theme, based on the ideal data; and
comparing the current state evaluation with the concept and generating a solution that leads a current state to an ideal state.

10. A non-transitory computer-readable recording medium storing a program causing a computer to execute processing of:
acquiring current state data regarding a current state in a theme in which a user seeks problem resolution;
generating a current state evaluation indicating an issue in the theme, based on the current state data;
acquiring ideal data regarding an ideal state in the theme;
generating a concept of the theme, based on the ideal data; and
comparing the current state evaluation with the concept and generating a solution that leads a current state to an ideal state.
